(19) United States
(12) Patent Application Publication
(10) Pub. No.: US 2016/0347977 A1
(43) Pub. Date: Dec. 1, 2016

(54) CURING AGENT, METHOD FOR MAKING THE SAME, AND STRUCTURAL ADHESIVE USING THE SAME

(71) Applicant: HON HAI PRECISION INDUSTRY CO., LTD., New Taipei (TW)

(72) Inventors: JHIH-KUEI GE, New Taipei (TW); MING-JEN CHANG, New Taipei (TW); TING-HSIEN LEE, New Taipei (TW)

(21) Appl. No.: 14/843,044

(22) Filed: Sep. 2, 2015

(30) Foreign Application Priority Data
May 28, 2015 (TW) 104117250

(51) Int. Cl. C09J 163/00; C08K 9/04

(52) U.S. Cl. CPC C09J 163/00; C08K 9/04

(57) ABSTRACT

A curing agent in a structural adhesive includes a plurality of spherical shells and a curing compound bonded to an outer surface of each of the plurality of spherical shells. Each spherical shell is formed of a plurality of primary magnetic nanoparticles. The spherical shells can be broken down under an applied frequency-varied magnetic field, allowing objects bonded by such adhesive to be separated. A method for making the curing agent, and a structural adhesive using the curing agent are also provided.

### FIELD

The subject matter generally relates to a curing of adhesives.

### BACKGROUND

Structural adhesives are usually used for bonding two workpieces together. A high bond strength is often required for the two workpieces bonded together. However, if the two workpieces bonded together need reworking, the two workpieces must be separated from each other. Thus, a structural adhesive having a high bond strength but is easy to be removed is needed.

### BRIEF DESCRIPTION OF THE DRAWINGS

Implementations of the present technology will now be described, by way of example only, with reference to the attached figures.

FIG. 1 is a diagrammatic view showing a curing compound being bonded to an outer surface of secondary magnetic nanoparticles to form a curing agent, according to an exemplary embodiment.

FIG. 2 is a flowchart of a method for making a curing agent according to an exemplary embodiment.

FIG. 3 is a diagrammatic view showing a structural adhesive formed by a parent mixture and the curing agents of FIG. 1, and the structural adhesive being broken down under a frequency-varied magnetic field.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

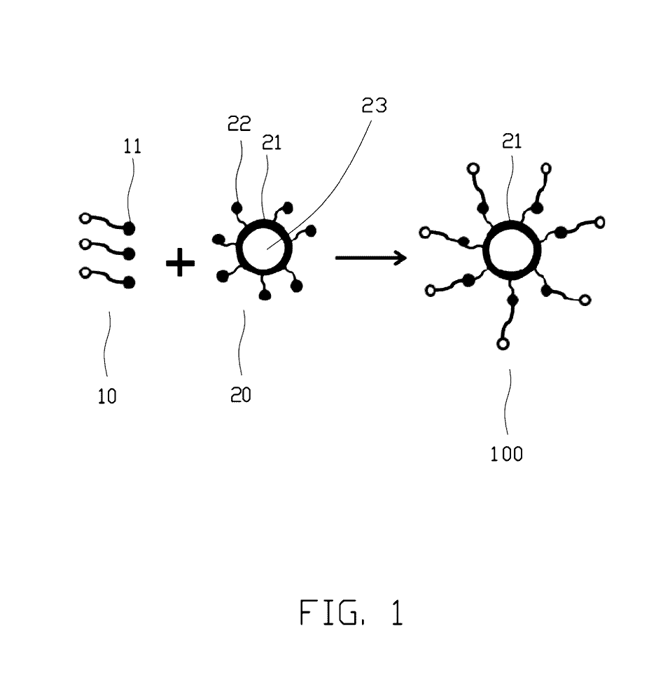

FIG. 1 illustrates an embodiment of a curing agent 100 comprising a plurality of spherical shells 21 and a curing compound 10 chemically bonded to an outer surface of each spherical shell 21. Each spherical shell 21 surrounds a hollow spherical core 23, and is composed of a plurality of primary magnetic nanoparticles. The spherical shell 21 may be broken into pieces under a frequency-varied magnetic field of between about 50 kHz to about 300 kHz. The frequency-varied magnetic field is produced by a device including a magnetic coil which can form magnetic field and a controller configured to control the magnetic coil to form the frequency-varied magnetic field.

In at least one embodiment, the curing agent 100 is formed from secondary magnetic nanoparticles 20 each comprising first functional groups 22 and a curing compound 10 comprising second functional groups 11. The first functional groups 22 react and bond with the second functional groups 11, thereby combining the curing compound 10 with the secondary magnetic nanoparticles 20 and so forming the curing agent 100. Each secondary magnetic nanoparticle 20 comprises one spherical shell 21 and the first functional groups 22 are bonded to an outer surface of the spherical shell 21. The secondary magnetic nanoparticles 20 have a mass percentage of about 0.5% to about 4.8% of the total mass of the curing agent 100. The curing compounds 10 have a mass percentage of about 95.2% to about 99.5% of the total mass of the curing agent 100.

In at least one embodiment, the first functional group 22 is hydroxyl (—OH). A primary magnetic nanoparticle may be selected from a group consisting of Fe₃O₄ magnetic nanoparticle, Fe₂O magnetic nanoparticle, MnFe₂O₄ magnetic nanoparticle, CoFe₂O₄ magnetic nanoparticle, and NiFe₂O₄ magnetic nanoparticle, or any combination thereof. A secondary magnetic nanoparticle 20 is composed of such primary magnetic particles.

The second functional group 11 may be selected from a group consisting of hydroxyl (—OH), amino (—NH₂), carboxyl (—COOH), and isocyanato group (—NCO), or any combination thereof. When the second functional group 11 is —OH, —NH₂, or —COOH, the first functional group 22 may undergo a dehydration reaction with the second functional group 11, thereby allowing the first functional group 22 and the second functional group 11 to be bonded together. When the secondary functional group 11 of the curing compound 10 is —NCO, the first functional group 22 may react with the second functional group 11 to generate —NHCOO, thereby allowing the first functional group 22 and the second functional group 11 to be bonded together.

In other embodiments, the first functional group 22 may be —NH₂, —COOH, or —NCO. The secondary functional group 11 may be —OH.

The curing compound 10 may be selected from a group consisting of aliphatic amine curing compound, aromatic amine curing compound, acylamino amine curing compound, and latent curing amine curing compound, or any combination thereof. The aliphatic amine curing compound may be selected from a group consisting of N-Aminoethylpiperazine, 1,4-Diaminecyclohexane, 1,2-diaminocyclohexane, isophorondiamine, ethylenediamine, diethylenetriamine, triethylenetetramine, tetraethylenepentamine, polyethylene polyamine, dipropylenetriamine, 1,1′-[[3-(dimethylamino)propyl]imino]bispropan-2-ol, 3-Diethylaminopropylamine, 2,2,4-trimethyl-6-hexanediamine, bis(6-aminohexyl)amine, N,N-Diethylethylenediamine, N,N,N′-Trimethyldiaminoethane, diethylamine, and polyethenoxyamine, or any combination thereof. The aromatic amine curing compound may be selected from a group consisting of 1,3-Phenylenediamine, 1,3-Benzenedimethanamine, 3,4′-Diaminodiphenylmethane, 3,3′-Methylenebisaniline, 4,4′-Diaminodiphenyl sulfone, 3,3′-Diamino diphenylsulfone, benzidine, 3,4-Diaminochlorobenzene, 3-Benzyloxybenzylhydrazine, mixture of 1,3-Phenylenediamine and 3,4′-Diaminodiphenylmethane, and ethylene-bis-tetrachlorophtalimide, or any combination thereof. The latent curing amine curing compound may be selected from a group consisting of dicyanodiamide and anhydrides, or any combination thereof.

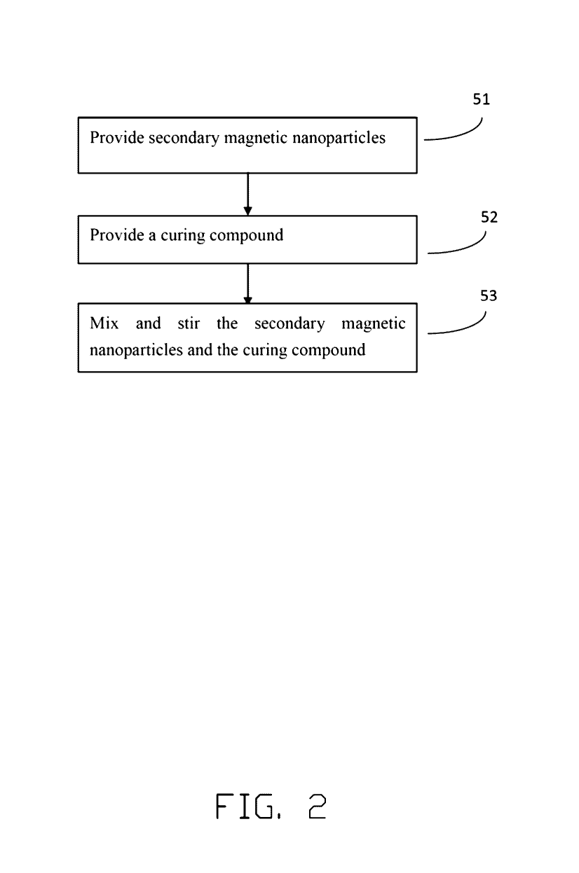

Referring to FIG. 2, a flowchart of a method for making the curing agent 100 is presented in accordance with an example embodiment. The example method is provided by way of example, as there are a variety of ways to carry out the method. The method subsequently described can be carried out using the configurations illustrated in FIG. 1, for example, and various elements of these figures are referenced in explaining example method. Each block shown in FIG. 2 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 51.

At block 51, secondary magnetic nanoparticles 20 are provided. Each secondary magnetic nanoparticle 20 includes the spherical shell 21 and a plurality of the functional groups 22 bonding to the outer surface of each spherical shell 21. A spherical shell 21 is formed by a plurality of the primary magnetic nanoparticles. The first functional groups 22 bonded to the spherical shells 21 of secondary magnetic nanoparticles 20 may be created by a surface chemical modification.

At block 52, the curing compound 10 is provided. The curing compound 10 includes at least one type of the second functional group 11 which may react with and then bond to the first functional groups 22.

At block 53, the secondary magnetic nanoparticles 20 and the curing compounds 10 are mixed and stirred at a temperature of about 40 degrees to about 120 degrees, causing the second functional groups 11 and the first functional groups 22 to undergo chemical reactions. The curing compounds 10 are thus bonded to the outer surface of the spherical shells 2l to form the curing agent 100. The secondary magnetic nanoparticles 20 have a mass percentage of about 0.5% to about 4.8% of the total mass of the curing agent 100. The curing compounds 10 have a mass percentage of about 95.2% to about 99.5% of the total mass of the curing agent 100.

In other embodiments, a catalyst may be added to the mixture to accelerate a reaction rate between the first functional groups 22 and the second functional groups 11.

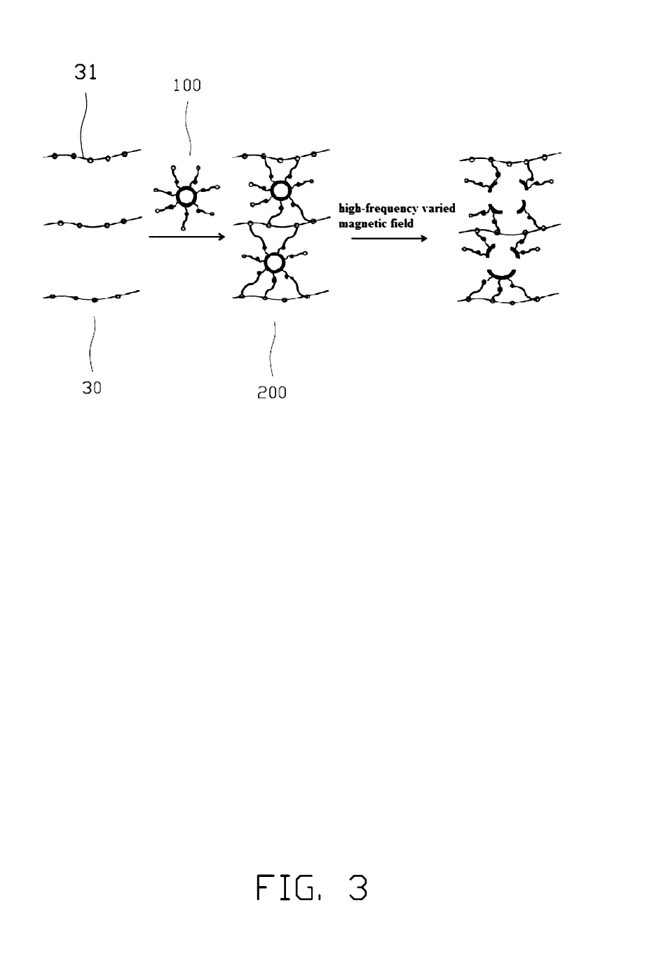

FIG. 3 illustrates an embodiment of a structural adhesive 200 including the curing agent 100. The structural adhesive 200 is configured to bond two pieces (not shown) together. The structural adhesive 200 includes a parent mixture 30 having a monomer 31 and the curing agent 100. The parent mixture 30 has a mass percentage of about 20% to about 80% of the total mass of the structural adhesive 200. The curing agent 100 has a mass percentage of about 0.5% to about 20% of the total mass of the structural adhesive 200.

The monomer 31 of the parent mixture 30 is a linear polymer. The linear polymers of the parent mixture 30 are connected to each other via the curing agent 100, thereby forming a structural adhesive 200 which has a cross-linking network structure. Since the spherical shells 21 of the curing agent 100 may be broken into pieces under a frequency-varied magnetic field, the cross-linking network structure of the structural adhesive 200 is broken down, and the linear polymers of the parent mixture 30 disconnect and separate from each other. Since the separated linear polymer is easily melted by heat or by a suitable solvent, the structural adhesive 200 may be easily removed from the surfaces of the workpieces.

The parent mixture 30 may be selected from a group consisting of epoxy resin, acrylic resin, phenolic resin, urea resin, organic siliconresin, furan resin, unsaturated polyester, polyimide, polybenzimidazole, phenolic aldehyde-pioloform, phenolic aldehyde-eurelon, phenolic aldehyde-epoxy resin, and epoxy polyamide, or any combination thereof.

The structural adhesive 200 may further include at least one of a diluent, a plasticizer, a flexibilizer, a filler, and a modifier. The diluent has a mass percentage of about 0.1% to about 70% of the total mass of the mass of the structural adhesive 200. The plasticizer has a mass percentage of about 0.1% to about 20% of the total mass of the mass of the structural adhesive 200. The flexibilizer has a mass percentage of about 0.1% to about 20% of the total mass of the mass of the structural adhesive 200. The filler has a mass percentage of about 0.1% to about 70% of the total mass of the mass of the structural adhesive 200. The modifier has a mass percentage of about 0.1% to about 5% of the total mass of the mass of the structural adhesive 200.

The diluent may be selected from a group consisting of low molecular weight epoxy resin, acrylic monomer, acetic ether, acetone, benzene, and methylbenzene, or any combination thereof.

The plasticizer may be selected from a group consisting of epoxidized soybean oil and phthalate, or any combination thereof.

The flexibilizer may be selected from a group consisting of carboxyl-terminated butadiene and butadiene-acrylonitrile copolymers (CTBN), amine-terminated butadiene (ATB), and butadiene-acrylonitrile copolymers (ATBN), or any combination thereof.

The filler may be selected from a group consisting of silica, talcum powder, calcium carbonate, titanium dioxide, and carbon black, or any combination thereof.

The modifier may be selected from a group consisting of polyethylene glycol, poly(propylene glycol), organo-siloxane, and fluorocarbon modified polyacrylate, or any combination thereof.

### EXAMPLE 1

The curing agent 100 was formed by 1,4-Diaminecyclohexane and Fe₃O₄ secondary magnetic nanoparticle including —OH. The Fe₃O₄ secondary magnetic nanoparticle had a mass percentage of 3% of the total mass of the curing agent 100. The 1,4-Diaminecyclohexane had a mass percentage of 97% of the total mass of the curing agent 100.

The structural adhesive 200 included epoxy resin, the above curing agent 100, low molecular weight epoxy resin, epoxidized soybean oil, and silica. The epoxy resin had a mass percentage of 60% of the total mass of the structural adhesive 200. The curing agent 100 had a mass percentage of 5% of the total mass of the structural adhesive 200. The low molecular weight epoxy resin had a mass percentage of 20% of the total mass of the structural adhesive 200. The epoxidized soybean oil had a mass percentage of 5% of the total mass of the structural adhesive 200. The silica had a mass percentage of 10% of the total mass of the structural adhesive 200.

### EXAMPLE 2

The curing agent 100 was formed by N,N-Diethylethylenediamine and Fe₃O₄ secondary magnetic nanoparticle including —OH. The Fe₃O₄ secondary magnetic nanoparticle had a mass percentage of 3% of the total mass of the curing agent 100. The 1,4-Diaminecyclohexane had a mass percentage of 97% of the total mass of the curing agent 100.

The structural adhesive 200 included epoxy resin, the above curing agent 100, low molecular weight epoxy resin, epoxidized soybean oil, and silica. The epoxy resin had a mass percentage of 60% of the total mass of the structural adhesive 200. The curing agent 100 had a mass percentage of 5% of the total mass of the structural adhesive 200. The low molecular weight epoxy resin had a mass percentage of 20% of the total mass of the structural adhesive 200. The epoxidized soybean oil had a mass percentage of 5% of the total mass of the structural adhesive 200. The silica had a mass percentage of 10% of the total mass of the structural adhesive 200.

### EXAMPLE 3

The curing agent 100 was formed by N,N-Diethylethylenediamine and Fe₃O₄ secondary magnetic nanoparticle including —OH. The Fe₃O₄ secondary magnetic nanoparticle had a mass percentage of 3% of the total mass of the curing agent 100. The 1,4-Diaminecyclohexane had a mass percentage of 97% of the total mass of the curing agent 100.

The structural adhesive 200 included epoxy resin, the above curing agent 100, low molecular weight epoxy resin, carboxyl-terminated butadiene and butadiene-acrylonitrile copolymers, and silica. The epoxy resin had a mass percentage of 60% of the total mass of the structural adhesive 200. The curing agent 100 had a mass percentage of 5% of the total mass of the structural adhesive 200. The low molecular weight epoxy resin had a mass percentage of 20% of the total mass of the structural adhesive 200. The carboxyl-terminated butadiene and butadiene-acrylonitrile copolymers had a mass percentage of 5% of the total mass of the structural adhesive 200. The silica had a mass percentage of 10% of the total mass of the structural adhesive 200.

The embodiments shown and described above are only examples. Even though numerous characteristics and advantages of the present technology have been set forth in the foregoing description, together with details of the structures and function of the present disclosure, the disclosure is illustrative only, and changes can be made in the detail, including in matters of shape, size, and arrangement of the parts within the principles of the present disclosure, up to and including, the full extent established by the broad general meaning of the terms used in the claims.

1. A curing agent comprising:
a plurality of spherical shells; and
a curing compound chemically bonded to an outer surface of each of the plurality of spherical shells;
wherein each of the plurality of spherical shells is comprised of a plurality of primary magnetic nanoparticles, and each of the plurality of spherical shells is able to be broken into pieces under a frequency-varied magnetic field.

2. The curing agent of claim 1, wherein the curing agent is formed from secondary magnetic nanoparticles each comprising first functional groups and a curing compound comprising second functional groups, the first functional groups react and bond with the second functional groups, thereby combining the curing compound with the secondary magnetic nanoparticles and so forming the curing agent; each of the plurality of secondary magnetic nanoparticles comprises one spherical shell, the first functional groups are bonded to the outer surface of each of the plurality of the spherical shells.

3. The curing agent of claim 2, wherein the secondary magnetic nanoparticles have a mass percentage of about 0.5% to about 4.8% of a total mass of the curing agent; the curing compounds have a mass percentage of about 95.2% to about 99.5% of the total mass of the curing agent.

4. The curing agent of claim 2, wherein the primary magnetic nanoparticle is selected from a group consisting of Fe₃O₄ magnetic nanoparticle, Fe₂O magnetic nanoparticle, MnFe₂O₄ magnetic nanoparticle, CoFe₂O₄ magnetic nanoparticle and NiFe₂O₄ magnetic nanoparticle, or any combination thereof.

5. The curing agent of claim 2, wherein the first functional group is —OH; the second functional group is selected from a group consisting of —OH, —NH₂, —COOH, and —NCO, or any combination thereof.

6. The curing agent of claim 2, wherein the first functional group is selected from a group consisting of —NH₂, —COOH, and —NCO, or any combination thereof; the second functional group is —OH.

7. The curing agent of claim 2, wherein the curing compound is selected from a group consisting of aliphatic amine curing compound, aromatic amine curing compound, acylamino amine curing compound, and latent curing amine curing compound, or any combination thereof.

8. A method for making a curing agent comprising:
providing secondary magnetic nanoparticles, each of the secondary magnetic nanoparticles comprising a spherical shell and a plurality of first functional groups bonding to an outer surface of the spherical shell, the spherical shell composed of a plurality of primary magnetic nanoparticles, and the spherical shell being able to be broken into pieces under a frequency-varied magnetic field;
providing a curing compound, the curing compound comprising at least one second functional group which is able to react with and then bond to the first functional groups; and
mixing and stirring the secondary magnetic nanoparticles and the curing compounds to cause the second functional groups and the first functional groups to bond together, thereby causing the curing compounds to be bonded to the outer surface of the spherical shells.

9. The method of claim 8, wherein the secondary magnetic nanoparticles and the curing compounds are stirred at a temperature of about 40 degrees to about 120 degrees.

10. The method of claim 8, wherein the secondary magnetic nanoparticles have a mass percentage of about 0.5% to about 4.8% of a total mass of the curing agent; the curing compounds have a mass percentage of about 95.2% to about 99.5% of the total mass of the curing agent.

11. The method of claim 8, wherein the first functional group is —OH; the second functional group is selected from a group consisting of —OH, —NH₂, —COOH, and —NCO, or any combination thereof.

12. The method of claim 8, wherein the first functional group is selected from a group consisting of —NH₂, —COOH, and —NCO, or any combination thereof the second functional group is —OH.

13. A structural adhesive comprising:
a parent mixture, a monomer of the parent mixture is a linear polymer; and
a curing agent configured to connect the linear polymers of the parent mixture together, thereby forming a cross-linking network structure, the curing agent comprising:
a plurality of spherical shells; and
a plurality of curing compounds chemically bonded to an outer surface of each of the plurality of spherical shells;
wherein each of the plurality of spherical shells is comprised of a plurality of primary magnetic nanoparticles, and each of the plurality of spherical shells is able to be broken into pieces under a frequency-varied magnetic field.

14. The structural adhesive of claim 13, wherein the curing agent is formed from secondary magnetic nanoparticles each comprising first functional groups and a curing compound comprising second functional groups, the first functional groups react and bond with the second functional groups, thereby combining the curing compound with the secondary magnetic nanoparticles and so forming the curing agent; each of the plurality of secondary magnetic nanoparticles comprises one spherical shell, the first functional groups are bonded to the outer surface of each of the plurality of the spherical shells.

15. The structural adhesive of claim 14, wherein the secondary magnetic nanoparticles have a mass percentage of about 0.5% to about 4.8% of a total mass of the curing agent; the curing compounds have a mass percentage of about 95.2% to about 99.5% of the total mass of the curing agent.

16. The structural adhesive of claim 14, wherein the primary magnetic nanoparticle is selected from a group consisting of Fe₃O₄ magnetic nanoparticle, Fe₂O magnetic nanoparticle, MnFe₂O₄ magnetic nanoparticle, CoFe₂O₄ magnetic nanoparticle and NiFe₂O₄ magnetic nanoparticle, or any combination thereof.

17. The structural adhesive of claim 14, wherein the first functional group is —OH; the second functional group is selected from a group consisting of —OH, —NH₂, —COOH, and —NCO, or any combination thereof.

18. The structural adhesive of claim 14, wherein the first functional group is selected from a group consisting of —NH₂, —COOH, and —NCO, or any combination thereof; the second functional group is —OH.

19. The structural adhesive of claim 14, wherein the curing compound is selected from a group consisting of aliphatic amine curing compound, aromatic amine curing compound, acylamino amine curing compound, and latent curing amine curing compound, or any combination thereof.
